(19) United States
(12) Patent Application Publication
(10) Pub. No.: US 2008/0154915 A1
(43) Pub. Date: Jun. 26, 2008

(54) NETWORK-BASED RECOMMENDATIONS

(75) Inventors: Gary W. Flake, Bellevue, WA (US); Lili Cheng, Bellevue, WA (US); David M. Chickering, Bellevue, WA (US); Michael Connolly, Seattle, WA (US); Alexander G. Gounares, Kirkland, WA (US); Jeffrey R. Hemmen, Renton, WA (US); Kamal Jain, Bellevue, WA (US); Leonard Smith, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/769,449

(22) Filed: Jun. 27, 2007

Related U.S. Application Data
(60) Provisional application No. 60/870,926, filed on Dec. 20, 2006.

(51) Int. Cl. G06F 17/30

(52) U.S. Cl. 707/10; 707/E17.032

(57) ABSTRACT

The claimed subject matter relates to an architecture that can utilize information obtained from a communications system and/or an associated content engine or model in order to facilitate enhanced content recommendations. The information can include content recommendations (e.g., from the content model) as well as information based upon social networking features of the communications system. For example, information such as referrals from friends, family, or other parties that are likely to have firsthand knowledge of interests, objectives, and/or desires of particular consumer that potentially offer a superior data set than conventional data mining by which to form a content recommendation.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” The entirety of this application is incorporated herein by reference.

### BACKGROUND

There has historically been a continuous struggle between advertisers and consumers with respect to sharing information. On the one hand, by acquiring information relating to the consumer, the advertiser can tailor ads or offers to be appropriate for the consumer, which, ultimately, can be beneficial for all parties involved. However, on the other hand, advertisers always want to reach consumers, yet oftentimes a consumer does not want to be bothered by the advertiser. Thus, many consumers simply refuse to sanction any sort of information sharing.

With the advent of the Internet and the ensuing meteoric rise of online purchasing, the information struggle has intensified. Advertising or content models track IP addresses to determine an approximate location for a user, and engage in countless other data mining activities in order to develop a demographic profile for the user. The models or systems that employ such models can then utilize the profile to make recommendations for content to serve to the user, which may or may not be appropriate. Ultimately, conventional models are largely based upon statistical or stochastic information, but, unfortunately, rarely ever have access to real inside information about a particular consumer, such as information that would be known to friends and family of the consumer, while usually not known by an advertiser.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises a computer-implemented architecture that can utilize information obtained from a communications system as well as from ad or content models in order to facilitate enhanced content recommendations. In accordance therewith, the architecture can receive content recommendations (e.g. from content models) as well as social network data that stems not simply from demographic-style data mining of conventional systems, but rather from personal and/or social contacts associated with a user. For example, portions of the social network data can originate from a member of the user's friend and family contact list maintained by the communication system. This and other data can be employed by the architecture to provide an enhanced content recommendation.

According to one aspect of the claimed subject matter, the social network data can be or include a referral for a particular product. Unlike conventional referrals, the claimed referral can be provided to an advertiser and/or ad host rather than to the potential customer. Moreover, according to another aspect, the referral can generate a referral fee, e.g. when the referral leads to a purchase of the advertised product. Furthermore, the referral fee can be based upon a variety of factors including but not limited to an increase in lead efficiency resulting from the enhanced recommendation over the initial recommendation, a historical accuracy of the referrer, a degree of certainty indicated by the referrer, and so on.

It is to be appreciated that the social network data that can be employed to make enhanced recommendations is not necessarily limited to advertisements, but can apply to other content as well. For instance, in accordance with an aspect of the claimed subject matter, the enhanced recommendation can apply to, e.g., a selection or ordering of search results as well as other content for which the communication system can provide to users.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system 100 that can utilize information obtained from a communications system to facilitate enhanced content recommendations.

FIG. 2 depicts a block diagram of a computer-implemented system that can present incentives to users who provide successful rewards.

FIG. 3 is a block diagram of a system that can provide additional aspects to facilitate more robust content recommendations.

FIG. 4 illustrates a block diagram of a system that can provide displayable content to a user.

FIG. 5 is an exemplary flow chart of procedures that define a computer-implemented method for employing referrals for selecting content to display.

FIG. 6 illustrates an exemplary flow chart of procedures that define a computer-implemented method for facilitating a referral fee in connection with a referral.

FIG. 7 is an exemplary flow chart of procedures that define a computer-implemented method for employing computer-based personal networking data for facilitating targeted content selection.

FIG. 8 depicts an exemplary flow chart of procedures defining a computer-implemented method that features additional aspects for employing computer-based personal networking data for facilitating targeted content selection.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

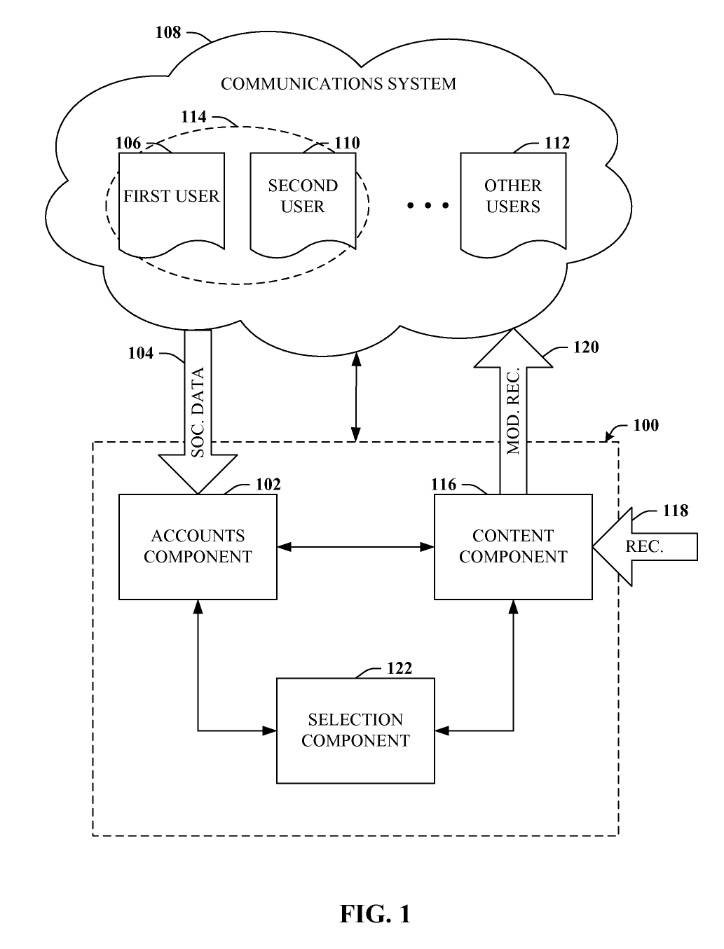

Referring now to the drawing, with reference initially to FIG. 1, a computer-implemented system 100 that can utilize information obtained from a communications system to facilitate enhanced content recommendations is depicted. Generally, the system 100 can interface with or be a component of a communications system 108. The system 100 can include an accounts component 102 that can receive social network data 104 that relates to a first user 106 of a communications system 108. The communications system 108, as used herein, is generally intended to refer to a system, apparatus, device, tool, or application that facilitates communication by way of a computer-based network such as the Internet. Moreover, the communications system 108 typically maintains accounts for users (e.g., the first user 106) of the system 108 and can require or utilize various authentication or informational procedures such as login IDs, password verifications, machine ID, cookies, and the like. Furthermore, the communications system 108 typically monitors or can be readily configured to monitor various transactions associated with the user accounts, all or portions of which can comprise the social network data 104.

In addition, the communications system 108 can manage or maintain associations and/or relationships between the first user 106, a second user 110, or virtually any number of other users 112. For example, the communications system 108 can maintain a friend or contact list (not shown) for each of the various users 106, 110, 112. Thus, if the first user 106 adds the second user 110 as a friend or a contact (or vice versa), then a relationship and/or association can exist between the first user 106 and the second user 110. These and other types of relationships or associations can be defined as a social circle 114 within the communications system 108. As depicted, social circle 114 includes the first user 106 and the second user 110, however, it is to be appreciated that the social circle 114 can include any number of other users 112 as well. As another example, if both the first user 106 and the second user 110 are members of a particular community or subscribe to a particular service or content, then a social circle 114 (e.g., a relationship or association) that includes users 106, 110 can be said to exist. It is to be appreciated that the users 106, 110, 112 can be associated with an individual, an entity, or multiple individuals and/or entities. Moreover, the users 106, 110, 112 as well as certain types of relationships between the users 106, 110, 112 and/or members of the social circle 114 can be tracked or represented anonymously.

In accordance with the foregoing, it is readily apparent that the communication system 108 can be applicable to a wide variety of communication mechanisms. For example, the communication system 108 can be, but is not limited to, a chat-based or email-based system, web-related accounts or services, web- or content-based browsers, and so on. It is to be appreciated that the communications system 108 can include a suite of products or services and/or can employ a universal user ID such that logging in to one portion of the suite can facilitate identification and/or verification for other portions of the suite.

It is to be appreciated that communications systems 108 may put forth substantial efforts directed toward tailoring and/or targeting of content to a particular user of the system 108. It is very common to employ demographic information as well as transaction histories of, say, the first user 106 in order to tailor content for the first user 106. For example, consider a communication system 108 that comprises a web-based search engine in which the first user 106 inputs a query. In response to the query, the search results can be displayed along with one or more advertisements. In such a case, it is common to utilize demographic information associated with the first user 106 in order to choose the advertisements from among many potential ads that will be displayed with the search results.

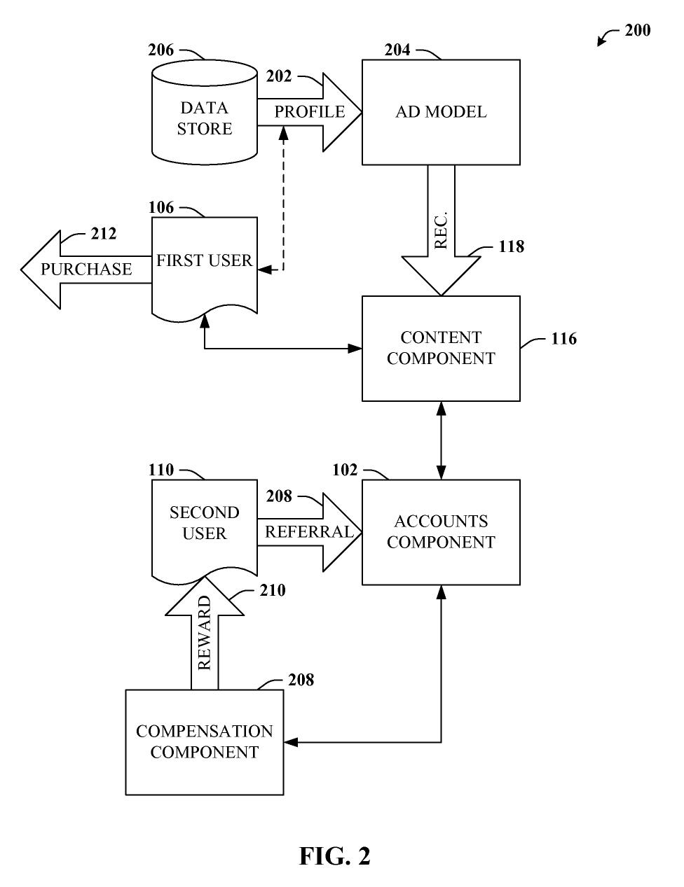

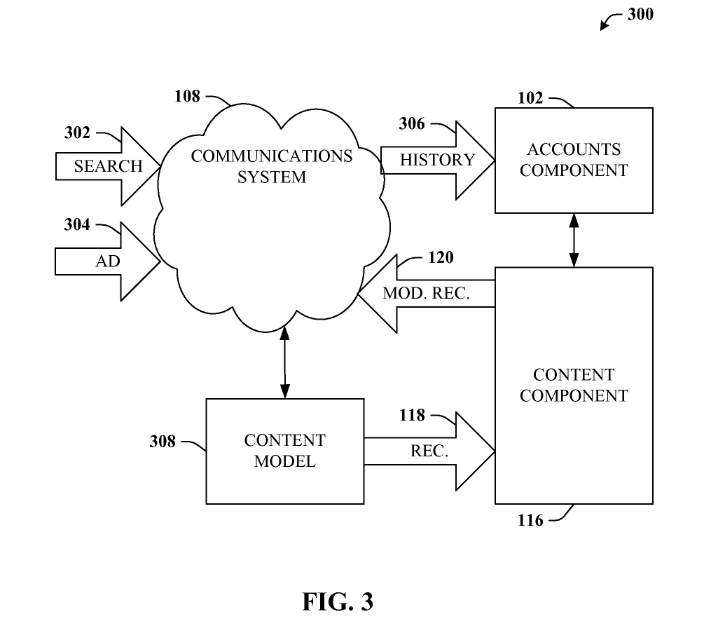

As another example, consider a communication system 108 that is an online provider of goods or services. In this case, the communication system can retain transaction histories associated with the first user 106. Thus, based upon, e.g., past purchases, the communication system 108 can select content and/or ads that are likely to result in additional purchases. In either case, the communication system 108 typically employs an ad or content model (further detailed in connection with FIGS. 2 and 3) to make recommendations (e.g., recommendation 118) pertaining to the particular content that should be selected for display based upon a profile or any other available data relating to the first user 106. It is readily apparent that identifying content that is most likely to yield a desired result, or content that is otherwise deemed to be the most suitable or appropriate can be an important function of the model given the constraints associated with the first user's 106 attention or level of satisfaction.

As indicated supra, the accounts component 102 can receive social network data 104 that generally relates to users included in a social circle 114 of the first user 106. According to one aspect of the claimed subject matter, the social network data 104 can include a referral for a product (e.g., good or service). The referral can originate from, e.g. the second user 110, or another user within a social circle 114 of the first user 106. Hence, the referral can be based upon first-hand knowledge rather than merely based upon stochastic data relating to what the communication system 108 knows or estimates about the first user 106.

For example, social circle 114 can be a proxy for real-world relationships. For instance, a first user's 106 friend list (or similar) generally includes users (e.g., the second user 110) with whom the first user 106 also maintains a real-world relationship. Whether professional, personal, or combinations thereof, the second user 110 is often privy to information such as goals, desires, behavior, likes, dislikes, interests, etc. that is difficult or impossible to obtain by the communications system 108, yet could be very beneficial to the communication system 108.

Consider the case in which the second user 110 accompanies the first user 106 for a few hours of shopping, or alternatively bumps into the first user 106 while shopping. The second user 110 observes the first user is extremely interested in contemporary furniture. The first user 106 explains that she has always wanted to redecorate her den in contemporary style, and with the quarterly bonus she is due to receive next month, she intends to accomplish this goal. Any of the above information obtained by the second user 110 can potentially be included in the referral, which can be supplied (e.g. by way of social network data 104) to the accounts component 102 by the communications system 108 or directly by the second user 110. Hence, the referral can include information such as the goal of redecorating the den in contemporary style, a very strong likelihood of a future purchase of contemporary furniture, a time frame of about one month, as well as various related factors such as the expected quarterly bonus, etc.

Continuing the discussion of FIG. 1, the system 100 can also include a content component 116 that can receive a recommendation 118 for content to serve to the first user 106. It is to be appreciated that the recommendation 118 can be provided by an ad or content model as described herein, which may or may not be included in the communications system 108. Hence, the recommendation 118 can be provided to the content component 116 by model or, alternatively, by the communications system 108. The recommendation 118 can be based upon a disparate profile that relates to the first user 106 (e.g., a profile that includes transaction histories, demographics . . . ), wherein the profile can be maintained either by the communications system 108, the model, or a combination of both.

In addition, the system 100 can also include a selection component 122 that can determine a modified recommendation 120 based upon the social data 104. The content component 116 can then transmit the modified recommendation 120 to an appropriate destination. It is to be understood that the modified recommendation 120 can be provided to the communications system 108, to a disparate model, or, as well, to a component that is otherwise responsible for selecting and/or recommending content to serve to the first user 106 on behalf of the communications system 108.

For example, in accordance with the scenario provided above in which the second user 110 provides a referral relating to the first user's 106 interest in contemporary furniture, the accounts component 102 can receive the referral. When the first user 106 logs into the communication system 108, say, to check an email account, an advertisement for a local specialist in contemporary furniture can be displayed, e.g. in an ad slot within the email client. It is to be appreciated that the advertisement that might otherwise be selected for display in the ad slot (e.g. based on the recommendation 118) can relate to an entirely different market segment and is often selected by the ad model, or selected based upon a recommendation 118 of the ad model. While the ad model may be very efficient in providing suitable recommendations 118, based upon keywords, demographics, transaction histories, or other data sets for which the model has access, conventional models do not employ (or have access to) much of the information that can be included in the referral.

Accordingly, the referral can facilitate a richer data set in order to supplement or replace the recommendation 118. Hence, the recommendation 118 may relate to an advertisement for a digital camera. That is, the communication system 108 or the model can identify the word camera in one of the emails in order to make the recommendation 118. As another example, the camera ad may be recommended based upon demographics known about the first user 106. As a third example, the camera ad may be recommended simple because the manufacturer bid the most for the ad slot. It is well known that inappropriate ads (or other content) are often detrimental to all parties involved in that they can potentially annoy or frustrate the user, cause an unnecessary expense for an advertiser who pays for displaying the ad, and can lower the user base for the ad host due to the annoyance or frustration of the user. Accordingly, by employing information that is potentially more accurate and often only available from sources with whom the first user 106 has an established and/or personal relationship, the modified recommendation 120 can be much more suitable than the recommendation 118. Accordingly, to complete the above example, the modified recommendation 120 can be a suggestion for an ad relating to contemporary furniture rather than an ad relating to a camera as the recommendation 118 suggested in the example.

Turning now to FIG. 2, a system 200 that can present incentives to users who provide successful rewards is illustrated. In general, the system 200 can include the accounts component 102 that can receive a referral 208 as substantially described herein. As depicted, the referral 208 is provided by the second user 110, however, it is to be appreciated that the referral can be forwarded to the accounts component 102 by intermediaries such as the communications system 108 and the referral 208 can be included in the social network data 104. The content component 116 receives the recommendation 118 from an ad model 204 as was detailed supra, wherein the recommendation 118 is based upon a user profile 202 that is compiled and stored in a data store 206 accessible by the ad model 204. As indicated by the broken lines, the profile 202 relates to the first user 106. For instance, the data store 206 can include transaction histories, demographics, associated with the first user 106, which can be extant in the profile 202.

The system 200 can also include a compensation component 208 that can provide a reward 210 to the second user 110 in exchange for the referral 208. According to an aspect of the claimed subject matter, the reward 210 can be contingent upon some performance by the first user 106. For example, consider the scenario in which the first user 106 is struggling with hair loss, and he often complains about the problem to his close friend, second user 110. The second user 110 can supply this and other related information in the form of the referral. In turn, the first user 106 can be provided very relevant content such as an advertisement for a hair loss treatment. However, the second user 110 may not be eligible for the reward 210 until or unless the first user 106 makes a purchase 212 of the hair loss treatment from the associated advertiser.

It is to be appreciated that while providing a reward for a referral (e.g., a referral fee) is well-known, the reward 210 and referral 208 behave in a manner that materially differs from convention schemes. For example, conventional schemes typically entail transactions in which the referrer refers the purchaser to the seller rather than referring the seller to the purchaser. Hence, the referral is verified by the purchaser who indicates who made the referral when he or she purchases the product from the seller. Thus, it is readily apparent that conventional schemes are substantially different from several aspects described herein.

In accordance with another aspect of the claimed subject matter, the reward 210 can be a function of an increase in lead efficiency facilitated by the modified recommendation 120 (and/or the referral 208) with respect to an estimated lead efficiency associated with the recommendation 118. In particular, the ad model 204 may estimate that serving a particular ad will yield $100 in expected profits per X impressions. However, if the ad has a higher performance based upon the referral 208, say, actual profits were $200 per X impressions, then the increase in lead efficiency is $100. Thus, the reward 210 can be some fraction and/or a function of the increase in lead efficiency. Moreover, it should be appreciated that there exists the possibility that the ad model 204 (or the communication system 108) is already aware to some degree that the first user 106 is a good candidate for an advertisement relating to hair loss treatment. However, in such a case, that fact will generally be reflected in the estimated lead efficiency for serving such an ad. Thus, the reward 210 can effectively differentiate between good leads and those that provide little or no added information or value beyond the recommendation 118.

As indicated supra, the ad associated with the recommendation 118 and the ad selected by the modified recommendation 120 need not be associated with the same product or even product class or market segment. Thus, returning to the contemporary furniture/camera scenario previously discussed, a subtle distinction arises in that an ad for a camera was recommended by the ad model 204. However, the modified recommendation 120 favored an ad for contemporary furniture. In this case, the increase in lead efficiency can be determined based upon a difference between the actual performance of the furniture ad compared to estimated performance of the next best alternative, the camera ad.

In accordance with another aspect, the reward 210 can be a function of a level of confidence indicated by the referral 208. For example, the second user 110 can include in the referral 208 an opinion that, e.g. the referral 208 stands an extremely high probability of resulting in purchase 212. It should be understood that obtaining such information can be useful to a seller of a product such as when determining how aggressive to advertise to the first user 106 and/or when to pay more over competitors.

In another aspect, the reward 210 can be a function of a referral accuracy associated with the second user 110. For example, the compensation component 208 can track referrals 208 over time in order to calculate the second user's 110 accuracy. A user with a very good history of making successful referrals 208 can, as with the level of confidence example supra, be employed to determine how much emphasis to place upon the referral. It is to be appreciated that the examples provided herein with regard to reward 210 are not necessarily mutually exclusive. Hence, a combination of aspects can be utilized simultaneously. For example, a reward 210 can be based upon a level of confidence as well as an accuracy and/or increase in lead efficiency.

Referring now to FIG. 3, an example system 300 that can provide additional aspects to facilitate more robust content recommendations is depicted. In the present example, the content component 116 can receive a recommendation 118 from a content model 308. The recommendation 308 can pertain to a selection of or an order of search results 302 associated with a keyword or advertisement impressions 304. For example, when the first user 106 performs a web search or is exposed to advertisements or other content, the content model 308 can be employed to select, rank, and/or order the results returned. Likewise, the content model 308 can select, rank, and/or order a set of advertisement impressions. Such data can be employed by the communications system 108 to display the results 302 or one or more advertisements 304 to the first user 106 based upon the recommendation 118 of the content model 308.

The recommendation 118 can also be received by the content component 116, as detailed supra, and the accounts component 102 can receive social network data 104, which, as depicted here, can include or be in the form of a history 306. According to an aspect of the claimed subject matter, the history 306 can be a navigation history 306 of search results 302 with an identical or substantially similar keyword. For example, the second user 110, who can be a close friend of or share similar interests with the first user 106 may have previously entered the same or a similar search 302. Based upon the navigation history 306 of the second user 110, the current results 302 for the first user 106 can be ordered, selected, or ranked according to the modified recommendation 120 rather than what is provided for by the recommendation 118.

It is to be appreciated that the navigation history 306 that is utilized to create the modified recommendation 120 can be based upon actions or behaviors of the first user 106 as well. For instance, consider a first user 106 who enters a keyword “dog” into a search tool. The communications system 108 (potentially with the aid of the content model 308) could provide the standardized search results 302, and display these results 302 to the first user 106. Next, suppose the first user 106 clicks on one of the displayed results 302, and then subsequently clicks a “Back” button on the browser to return to the original displayed search results 302 to, e.g., select another link relating to dogs.

Based potentially upon a type, category, and/or classification of the initial link chosen (e.g., navigation history 206) by the first user 106, the original search results 302 can be redefined according to a modified recommendation 120. For example, if the first user 106 initially selected a generic link about dog such as a dictionary, encyclopedia, wiki, or the like, then it can be potentially inferred that the first user 106 desires general dog information. Thus, when the first user 106 returns to the original results 302, such results can be dynamically and/or automatically modified to more highly weight or rank links to general information about dogs. In contrast, had the first user 106 instead initially selected an expert research paper relating to dietary suggestions for dog breeders, then the modified recommendation 120 can be employed to suitably return a different set of search results 302. In essence, based upon the navigation history 306 of the first user 106, subsequent results 302 can be tailored in a useful and convenient manner.

In another aspect of the claimed subject matter, the history 306 can be a transaction history 306 associated with the second user 110. In accordance therewith, the modified recommendation 120 can differ from the recommendation 118 in this aspect based upon a transaction history 306 of, e.g., other users within one of the first user's 106 social circles 114. It is to be appreciated that the transaction history 306 can pertain to a previous purchase of a product or, additionally or alternatively, pertain to a communication between the first user 106 and the second user 110.

In the former case, if the transaction history 306 includes information indicating that one or even several users in a social circle 114 of the first user 106 previously purchased a particular product, such information can, in some cases be suggestive of a likelihood that the first user 106 will be interested in the product as well. In the latter case, the transaction history 306 can pertain to, e.g. an email or chat message from or to the first user 106. For example, an email or chat message can provide an indication of what the first user 106 desires (e.g., an email to a close friend with a link to a wanted product), or a suggestion from the second user 106 providing an idea for the first user 106 (e.g., a chat message suggesting a product to buy).

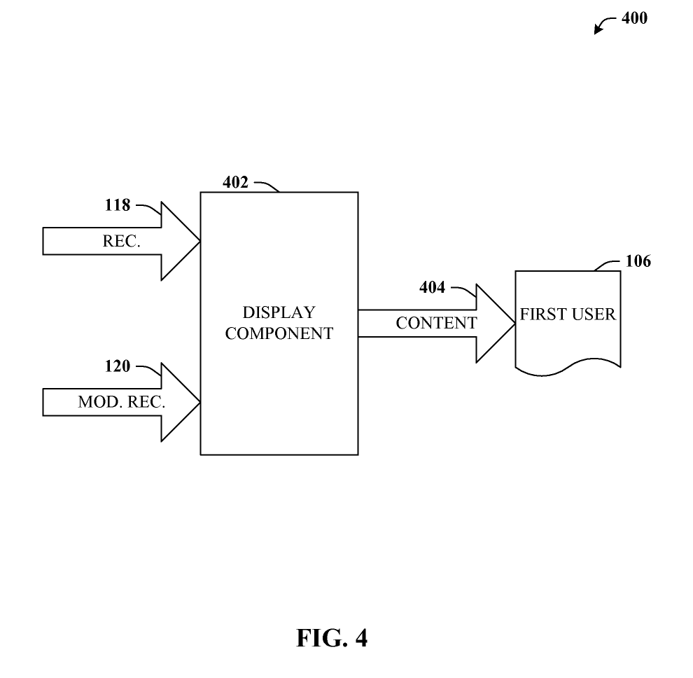

Turning briefly to FIG. 4, an exemplary system 400 that can provide displayable content to a user can be found. The system 400 can include a display component 402 that can output content 404 associated with one or both of the recommendation 118 or the modified recommendation 120. It is to be understood that the display component 402 can be communicatively couple to or a component of the communication system 108. Furthermore, the recommendation 118 can be supplied by an ad or content model, whereas the modified recommendation 120 can be supplied by the content component 116 or selection component 122 as substantially described herein. Typically, the content 404 will be associated with the modified recommendation 120 unless no modified recommendation 120 is provided for the particular content 404, in which case the recommendation 118 can be utilized for selecting the content 404.

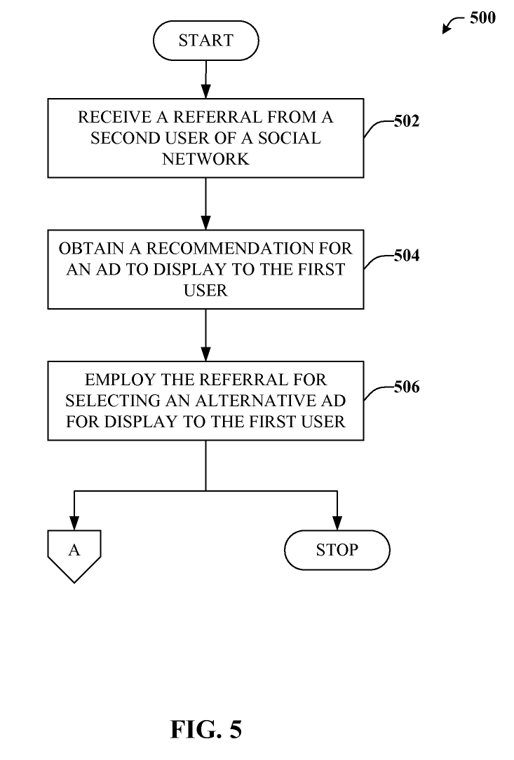

FIGS. 5, 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 5, an exemplary computer-implemented method 500 for employing referrals for selecting content to display is illustrated. Generally, at reference numeral 502, a referral for a product can be received from a second user of a communications system identifying an associated first user. For example, the referral can identify the first user for whom the product (or and advertisement thereof) might be especially well suited. Typically, the second user is associated with the first user in a social sense and, thus, often has first person knowledge about the first user that conventional advertising or other content engines or models do possess. For example, the first can be on a friend list of the second user that is maintained by the communication system. Hence, the second user can conveniently select the first user from the friend list and input the product being referred as well as any other potentially relevant information.

At reference numeral 504, a recommendation can be obtained from an ad model, wherein the recommendation can be directed to an advertisement to display to the first user. For example, while utilizing the communication system, the first user will be exposed to many advertising opportunities for which conventional communication systems employ an engine or model (e.g., the ad model) to determine which content is most appropriate vis-à-vis the situation at hand and what is known about the first user.

At reference numeral 506, the referral can be employed for selecting for display to the first user an alternative associated with the product. For instance, while the ad model recommends the advertisement discussed at act 504, generally based upon a scarce set of demographics, the alternative advertisement can be recommended based upon the product indicated in the referral.

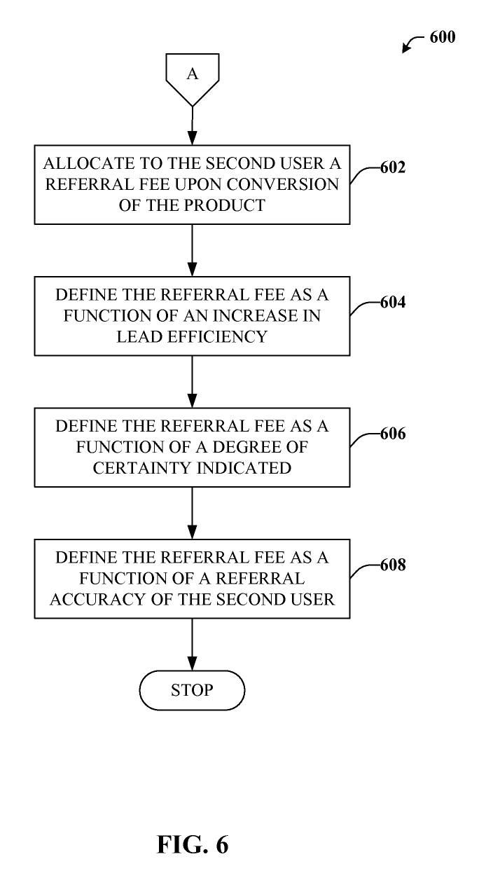

With reference now to FIG. 6, an exemplary computer-implemented method 600 for facilitating a referral fee in connection with a referral is illustrated. Typically, at reference numeral 602, a referral fee can be allocated to the second user when the advertisement results in a conversion of the product. In particular, the referral that resulted in selecting the alternative advertisement at act 506 can result in a reward to the second user (e.g., referrer) contingent upon the first user's purchase of the referred product or other suitable outcome.

At reference numeral 604, the referral fee can be defined as a function of an increase in lead efficiency resulting from the referral. Thus, for example, the amount of the referral fee can be directly proportional to the gain in lead efficiency of the alternative advertisement over the advertisement recommended by the ad model. Hence, if the communications system expected a revenue of X dollars per impression of the recommended advertisement, yet observed a revenue of Y dollars per impression for the alternate advertisement, where Y is greater than X, then the increase in lead efficiency can be described as Y−X, and the referral fee can be set to some portion of this increase.

At reference numeral 606 the referral fee can be defined as a function of a degree of certainty indicated by the referral. According to the present aspect, the referral fee can include an indication of certainty associated with the referral, and the referral fee can be weighted accordingly. In yet another aspect, at reference numeral 608, the referral fee can be defined as a function of a referral accuracy of the second user. Thus, users who have an excellent history of accurate referrals can be remunerated more or at a higher rate than other users who have a poor history with regard to referrals.

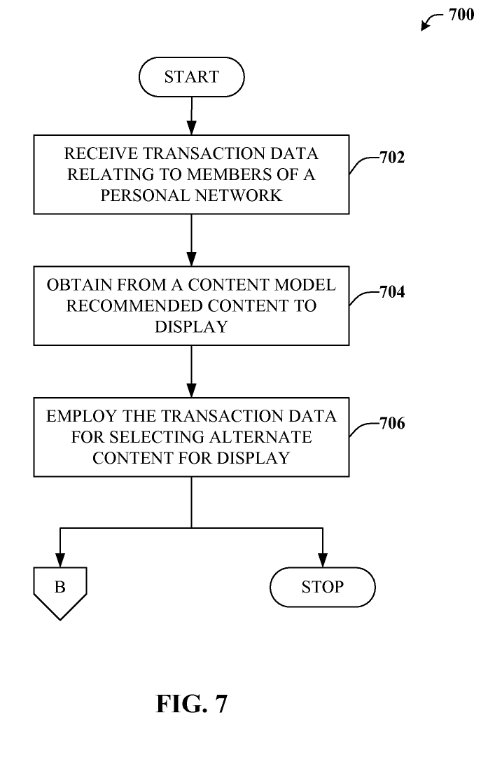

FIG. 7 depicts a computer-implemented method 700 for employing computer-based personal networking data for facilitating targeted content selection. Generally, at reference numeral 702, transaction data for transactions involving members included in a personal network can be received. Typically, the transactions pertain to intra-system (e.g., communication system 108) communications, content navigation, or purchases by a second user who is associated with a first user (e.g., in the same social circle 114). In particular, the transaction data can pertain to emails or chat messages (e.g., intra-system communications) between the first and second user. In other situations, the transaction data can pertain to selections or behaviors in connection with the content (e.g., content navigation), as well previous purchases by the second user.

At reference numeral 704, content recommended for display can be obtained from a content model. For instance, search results or an ad accompanying the search results or accompanying intra-system communications can represent the suitable types of content for which a content model is often relied upon to provide recommendations. At reference numeral 706, the transaction data can be employed for selecting alternate content for display, in particular content that is distinct from that which was recommended by the content model.

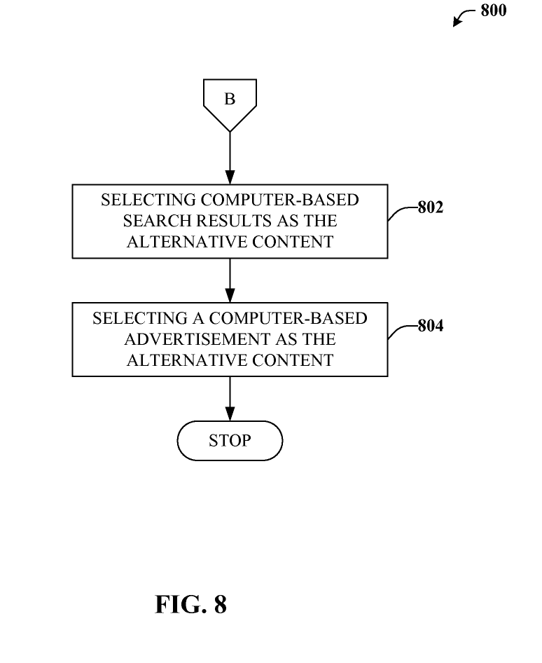

Turning briefly to FIG. 8, a computer-implemented method 800 that features additional aspects for employing computer-based personal networking data for facilitating targeted content selection is illustrated. In general, at reference numeral 802, computer-based search results can be selected as the alternative content, whereas at reference numeral 804, computer-based advertisements can be selected as the alternative content.

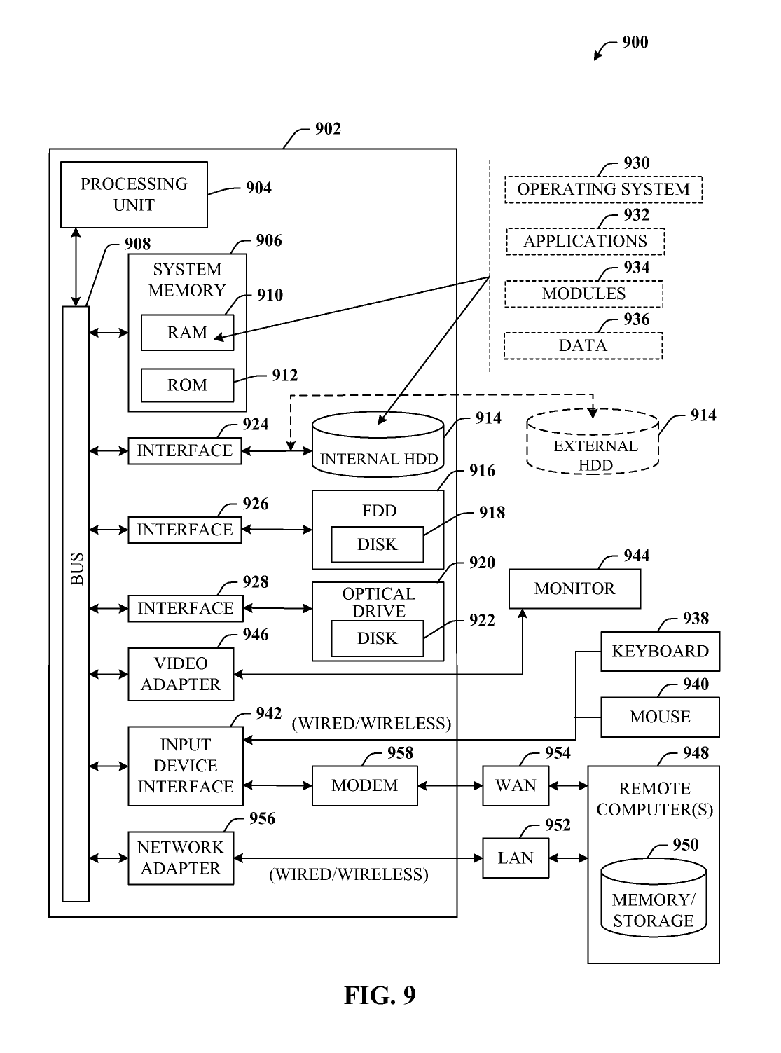

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic 10BaseT wired Ethernet networks used in many offices.

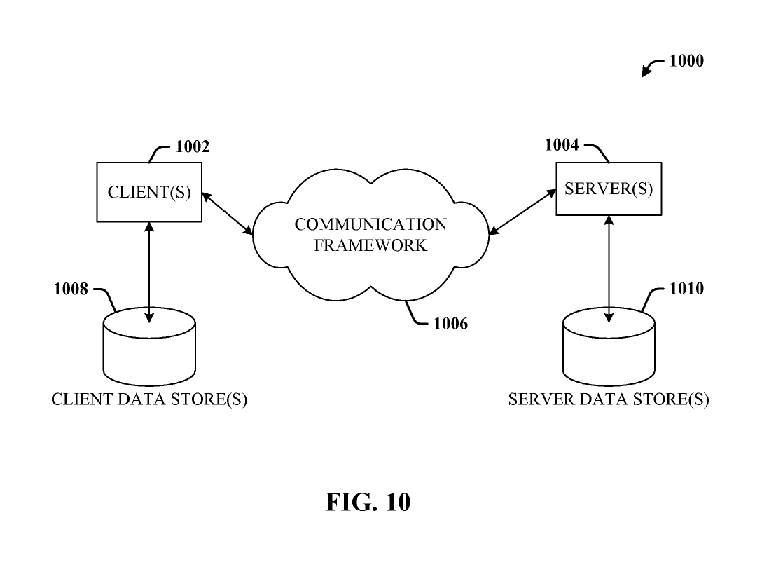

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implement system that utilizes information obtained from a communications system to facilitate enhanced content recommendations, comprising:
an accounts component that receives social network data that relates to a first user of a communications system or to an associated second user of the communications system;
a content component that receives a recommendation for content to serve to the first user, and that provides a modified recommendation for content to serve to the first user; and
a selection component that determines the modified recommendation based upon the social network data.

2. The system of claim 1, the first user and the second user share a social circle.

3. The system of claim 1, the recommendation is based upon a disparate profile that relates to the first user.

4. The system of claim 1, the social network data includes a referral for a product from the second user.

5. The system of claim 4, further comprising a compensation component that provides a reward to the second user when the first user purchases the product.

6. The system of claim 5, the reward is a function of an increase in lead efficiency facilitated by the modified recommendation with respect to an estimated lead efficiency associated with the recommendation.

7. The system of claim 5, the reward is a function of a level of confidence indicated by the referral.

8. The system of claim 5, the reward is a function of a referral accuracy associated with the second user.

9. The system of claim 1, the recommendation pertains to a selection of or an order of at least one of: search results associated with a keyword or advertisement impressions.

10. The system of claim 9, the social network data includes a navigation history of search results associated with an identical or a substantially similar keyword.

11. The system of claim 9, the social network data includes a transaction history associated with the second user.

12. The system of claim 11, the transaction history pertains to a purchase of a product.

13. The system of claim 11, the transaction history pertains to a communication between the first user and the second user.

14. The system of claim 1, further comprising a display component that outputs the content associated with the recommendation or the modified recommendation to the first user.

15. A computer-implemented method for employing referrals for selecting content to display, comprising:
receiving a referral for a product from a second user of a communications system identifying an associated first user;
obtaining from an ad model a recommendation for an advertisement to display to the first user; and
employing the referral for selecting for display to the first user an alternate advertisement associated with the product.

16. The method of claim 15, further comprising allocating to the second user a referral fee when the alternative advertisement results in a conversion of the product.

17. The method of claim 16, further comprising at least one of the following acts:
defining the referral fee as a function of an increase in lead efficiency resulting from the referral;
defining the referral fee as a function of a degree of certainty indicated by the referral; or
defining the referral fee as a function of a referral accuracy of the second user.

18. A computer-implemented method for employing computer-based personal networking data for facilitating targeted content selection, comprising:
receiving transaction data for transactions involving members included in a personal network, the transactions pertaining to purchases, navigation, or intra-system communications;
obtaining from a content model recommended content to display; and
employing the transaction data for selecting alternate content for display.

19. The method of claim 18, further comprising selecting computer-based search results as the alternative content.

20. The method of claim 18, further comprising selecting a computer-based advertisement as the alternative content.
